(19) United States
(12) Patent Application Publication
(10) Pub. No.: US 2018/0338638 A1
(43) Pub. Date: Nov. 29, 2018

(54) Smart Skewer

(71) Applicants: Joceline Andraos, Riverside, CA (US); Fady Najm, Riverside, CA (US)

(72) Inventors: Joceline Andraos, Riverside, CA (US); Fady Najm, Riverside, CA (US)

(21) Appl. No.: 15/603,464

(22) Filed: May 24, 2017

(51) Int. Cl. A47J 37/04; A47J 43/28

(52) U.S. Cl. CPC A47J 37/04; A47J 43/28

(57) ABSTRACT

It is a stainless skewer with two heat sensors built in, in the middle, each one is facing one side and are connected to a thermometer in the handle of the skewer. Both heat sensors are making contact with a piece of meat. During cook time, the heat sensors capture the inside temperature of the meat and transferred it to the thermometer to alert the chef.

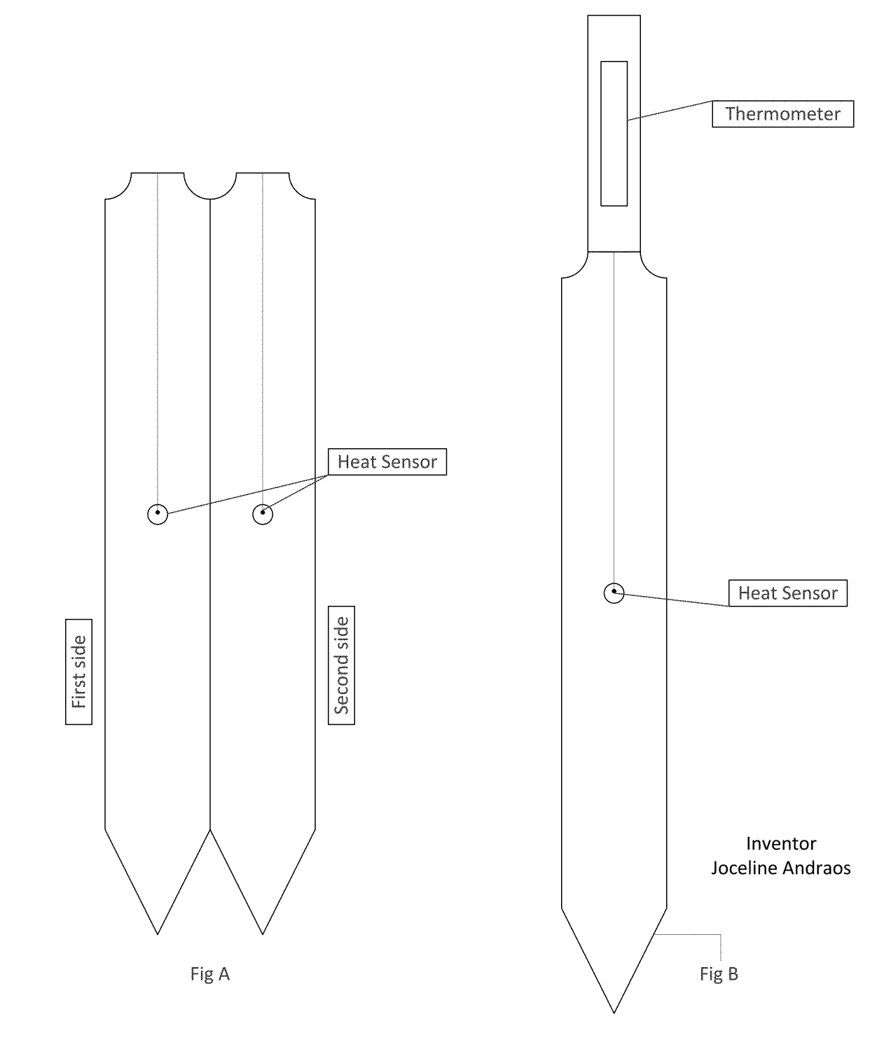

Smart Skewer consists of a stainless steel skewer with built in two heat sensors in the middle, each one facing one side, as shown in the drawing (Drawing A—Fig A). They are connected to a thermometer in the handle of the skewer, as shown in (Drawing A—Fig B) for temperature reading and cook time setup. The two sensors, located at the center of the skewer which are flushed with the flat surface of the skewer, make contact with piece of meat.

At barbecue time the thermometer reads the inside meat temperature through the sensors, and alert the chef of the meat temperature to determine the cook time.

To build this skewer, it starts as a sheet of stainless steel as shown in figure (Drawing A—Fig A). The cut sheet represents the two sides of the skewer. Each of the two heat sensors are installed in a hole as shown in (Drawing A—Fig A) where they make contact with meat. When the sensors are installed and their wires are run up to the skewer handle area, the sheet is bended in the middle and welded all the way around, to form the stainless steel smart skewer as shown in (Drawing A—Fig B). The handle with the thermometer is installed and connected to the heat sensors throw the wires.

1. Smart Skewer is the first and only barbecue skewer with two heat sensors that are permanently installed in the middle of the stainless steel skewer. They give real time readings for the meat temperature to a thermometer device in the skewer handle.
The two heat sensors are permanently located in the middle of the stainless steel skewer, each one facing one side. Each sensor is connected with a wire that runs inside the skewer until the handle.
The handle includes a digital thermometer connected to the two sensors to measure the temperature at the sensor's contact with the piece of meat and display it on a small screen. The thermometer can be configured at a certain temperature to generate an audible alarm to the chef that the meat is cooked.
The handle that includes the thermometer can be removed from the skewer in order to make it easy to wash the skewer.
